(19) United States
(12) Patent Application Publication
(10) Pub. No.: US 2026/0286028 A1
(43) Pub. Date: Sep. 24, 2026

(54) MODIFIED BIO-BASED REACTIVE MONOMER CONTAINING COMPOSITIONS AND METHODS OF MAKING AND USING THE SAME

(71) Applicant: SOPREMA, Inc., Wadsworth, OH (US)

(72) Inventor: Robert Vincent MORFORD, Wadsworth, OH (US)

(21) Appl. No.: 19/490,056

(22) PCT Filed: Jun. 7, 2024
(86) PCT No.: PCT/US2024/032930

§ 371 Date: Dec. 4, 2025

Related U.S. Application Data
(60) Provisional application No. 63/472,055, filed on Jun. 9, 2023.

(51) Int. Cl. C08F 220/06

(52) U.S. Cl. CPC C08F 220/06

(57) ABSTRACT

A composition comprising a first modified bio-based reactive acrylic monomer, and optionally a second different modified bio-based reactive acrylic monomer, wherein the first and second modified bio-based reactive acrylic monomers are present in an amount of about 1 wt. % to about 70 wt. %, based on the total weight of the composition. Also provided are substrates coated with the composition, such as a roof, wall, or deck substrate.

### TECHNICAL FIELD

The present disclosure relates to modified bio-based reactive monomer containing compositions, processes for making and using the modified bio-based reactive monomer containing compositions, and building and construction compositions and systems including the modified bio-based reactive monomer containing compositions.

### BACKGROUND

Conventional reactive monomer containing compositions include petroleum-based acrylic monomers. Such compositions provide many desirable performance characteristics, such as excellent waterproofing characteristics. However, environmental, economic and sustainability challenges limit the use of products derived from petroleum. The major challenge with bio-based reactive monomers has been the inability to achieve comparable performance of similar reactive monomers derived from petroleum sources. After extensive research, Applicant has developed modified bio-based reactive monomer containing compositions that achieve comparable or better performance characteristics, as compared to conventional compositions that contain petroleum-based acrylic monomers.

### SUMMARY

The present disclosure relates to a composition comprising a first modified bio-based reactive acrylic monomer, and optionally a second different modified bio-based reactive acrylic monomer, wherein the first and second modified bio-based reactive acrylic monomers are present in an amount of about 1 wt. % to about 70 wt. %, based on the total weight of the composition.

In addition to excellent structural durability, tensile strength, load-bearing performance, elongation properties, excellent flow and surface properties, and chemical and UV resistance, the disclosed modified bio-based reactive monomer containing composition achieves comparable or better performance properties, as compared to those of conventional petroleum-based reactive monomer containing compositions.

The present disclosure also relates to the surprising finding that the modified bio-based reactive monomer containing composition is capable of rapid curing. As demonstrated by the examples described herein, the disclosed modified bio-based reactive monomer composition exhibits a comparable or faster cure time, as compared to conventional petroleum-based reactive monomer containing compositions.

Additionally provided is a method comprising mixing a composition comprising a first modified bio-based acrylic monomer, and optionally a second different modified bio-based acrylic monomer, with at least one initiator, and contacting a substrate with the mixture to form a coating or membrane system. In certain embodiments, the present composition is used with at least one initiator. In further embodiments, the present composition is used with two or more different initiators. In yet further embodiments, the present composition is used without an initiator.

Also disclosed is a building envelope protection system comprising the modified bio-based reactive monomer containing composition. As used herein, “building envelope” refers to the entire outer shell of a building, such as, walls, roof, windows and doors and the layers of building materials and components associated therewith. The disclosed modified bio-based reactive monomer containing composition can be used as a component to provide a complete, weather protection system.

Also disclosed is a process for the preparation of a roofing and waterproofing system, wherein a composition comprising about 1 wt. % to about 70 wt. % of a first modified bio-based acrylic monomer, and optionally a second different modified bio-based acrylic monomer, based on the total weight of the composition, is applied to at least a portion of a substrate and allowed to cure. In certain embodiments, the composition is configured to cure via free-radical polymerization. The composition can be readily cured to form a coating, a membrane, a component of a building envelope system, an adhesive, a primer, a vapor barrier, an air barrier, insulation, or the like. The reactive modified bio-based monomer containing composition is also suitable in the field of civil engineering, for example, the composition may be applied to bridges, tunnels, pipes, and the like.

Also disclosed is a waterproofing system comprising: a substrate; and a bio-based reactive monomer containing composition applied to at least a portion of the substrate, wherein the composition comprises a first modified bio-based acrylic monomer, and optionally a second different modified bio-based acrylic acrylate monomer, wherein the first and second modified bio-based acrylic monomers are present in an amount of about 1 wt. % to about 70 wt. %, based on the total weight of the composition.

Additionally disclosed is a kit comprising i) a composition comprising a first modified bio-based acrylic monomer, and optionally a second different modified bio-based acrylic monomer, ii) an optional reinforcing material and iii) at least one initiator.

### DETAILED DESCRIPTION

The following text sets forth a broad description of numerous different embodiments of the present disclosure. The description is to be construed as exemplary only and does not describe every possible embodiment since describing every possible embodiment would be impractical, if not impossible. It will be understood that any feature, characteristic, component, composition, ingredient, product, step or methodology described herein can be deleted, combined with or substituted for, in whole or part, any other feature, characteristic, component, composition, ingredient, product, step or methodology described herein. Numerous alternative embodiments could be implemented, using either current technology or technology developed after the filing date of this patent, which would still fall within the scope of the claims. All publications and patents cited herein are incorporated herein by reference.

The terms “comprises,” “comprising,” “has,” “having,” “includes,” “including,” “contains,” “containing,” or any other variation are open-ended and are intended to cover a non-exclusive inclusion of elements, such that an article, apparatus, compound, composition, combination, method, or process that “comprises,” “has,” or “includes,” or “contains” a recited list of elements does not include only those elements but may include other elements not expressly listed, recited or written in the specification or claims. An element or feature proceeded by the language “comprises . . . a,” “contains . . . a,” “has . . . a,” or “includes . . . a” does not, without more constraints, preclude the existence or inclusion of additional elements or features in the article, apparatus, compound, composition, combination, method, or process that comprises, contains, has, or includes the element or feature.

The terms “a” and “an” are defined as one or more unless expressly stated otherwise or constrained by other language herein. An element or feature proceeded by “a” or “an” may be interpreted as one of the recited element or feature, or more than one of the element or feature.

The terms “about,” “approximately,” “essentially,” “substantially,” any other version thereof, or any other similar relative term, or similar term of approximation, are defined as being close to as understood by one having ordinary skill in the art. By way of non-limiting, illustrative embodiments, these terms are defined to be within 10% of a recited value, or defined to be within 5% of a recited value, or defined to be within 4% of a recited value, or defined to be within 3% of a recited value, or defined to be within 2% of a recited value, or defined to be within 1% of a recited value, or defined to be within 0.5% of a recited value, or defined to be within 0.25% of a recited value, or defined to be within 0.1% of a recited value.

It should be understood that when an amount in weight percent is described in the present disclosure, it is intended that any and every amount within the range, including the end points, is to be considered as having been expressly disclosed. For example, the disclosure of “a range of from about 1 to about 10” is to be read as indicating each and every possible number along the continuum between about 1 and about 10. It is to be understood that the inventors appreciate and understand that any and all data points within the range are to be considered to have been specified, and that the inventors have possession of the entire range and all points within the range.

The compositional weight percentages disclosed herein are based on the total weight of the reactive resin composition. It will be understood to one of ordinary skill in the art that the total weight percent of the reactive resin composition cannot exceed 100%. For example, a person of ordinary skill in the art would easily recognize and understand that a composition comprising about 1 to about 70 weight percent of the first and optional second modified bio-based acrylic monomer, about 10 to about 30 weight percent of a filler, about 0.1 to about 5 weight percent of an oxygen barrier, about 0.1 to about 5 weight percent of an accelerator, and about 1 to about 5 weight percent of a crosslinking agent will not exceed 100%. A person of ordinary skill in the art would understand that the amount of the ingredients will be adjusted to include the desired amount of these components without exceeding 100% by weight of the composition.

For the avoidance of doubt, preferences, options, particular features and the like indicated for a given aspect, feature or parameter of the invention should, unless the context indicates otherwise, be regarded as having been disclosed in combination with any and all other preferences, options, particular features and the like as indicated for the same or other aspects, features and parameters of the invention.

The present disclosure relates to the surprising finding that petroleum-based acrylic monomers can be partially or completely replaced with modified bio-based reactive acrylic monomers without sacrificing performance characteristics, such as, cure time, tensile strength, elasticity, water resistance, adhesion and stability to aging.

Disclosed is a composition comprising a first modified bio-based acrylic monomer, and optionally a second different modified bio-based acrylic monomer, wherein the first and second modified bio-based acrylic monomers are present in an amount of about 1 wt. % to about 70 wt. %, based on the total weight of the composition. The composition can be used as a roofing system, a waterproofing system and/or building envelope protection system. Without limitation, the waterproofing system can be used on balconies, terraces, parking decks, ramps, roofs, and the like. Unless otherwise specified or made clear from the context, the term “composition” includes a first modified bio-based reactive acrylic monomer.

As used herein, the term “bio-based” refers to a material made partially or entirely from biological materials obtained or produced from living organisms such as plants, trees, algae, bacteria, yeasts, fungi, protozoa, insects, and animals that are renewable raw materials. The term “bio-based” also refers to compositions from natural or biological sources, including derivatives or modifications thereof.

The term “monomer” as used refers to a molecule that can undergo polymerization. In particular, it will be understood that a “monomer” refers broadly to a monomer unit (or type of monomer), and not to a single monomer entity per se. The term modified bio-based monomers refers to the introduction of functional groups such as acrylic groups, or non-functional groups.

The term “acrylic monomer” refers to all types of acrylic and methacrylic monomers. The acrylic monomer may be selected from: acrylic and methacrylic acids, salts of acrylic and methacrylic acids, esters formed from acrylic and methacrylic acids, or alkyl acrylates and alkyl methacrylates. In certain embodiments, a bio-based fatty acid ester, which can take the form of a plant oil, seed oil, animal fat, animal oil, or combinations thereof, is converted into reactive acrylic monomers.

In certain embodiments, the first and second modified bio-based reactive acrylic monomers are plant-based, animal-based, or derived from a genetically engineered host biomass. In certain embodiments, the genetically engineered host biomass is bacteria, yeast, fungi, algae, cyanobacteria or mixtures thereof. In certain embodiments, the first and second modified bio-based reactive acrylic monomers are seed-based oils or vegetable-based oils, or fatty acid ester derivatives.

In certain embodiments, the modified bio-based reactive monomer is derived from a vegetable oil containing at least one unsaturated group. The phrase “vegetable oil” refers to any lipid compound derived from any natural source such as a plant or vegetable. Many vegetable oils contain esters of fatty acids in the form of triglycerides. Triglycerides are glycerin esterified with either saturated or unsaturated fatty acids. Exemplary triglyceride esters of such fatty acids found in vegetable oils include oleic acid, linoleic acid, and linolenic acid.

In certain embodiments, the vegetable-based oil is selected from at least one of: grapeseed oil, palm oil, castor oil, sesame oil, safflower oil, sunflower oil, safflower oil, alfalfa oil, marrow oil, soybean oil, linseed oil, peanut oil, olive oil, jojoba oil, tobacco seed oil, cottonseed oil, coconut oil, rapeseed oil, canola oil, corn oil, and lesquerella oil, avocado oil, shea oil, cashew nut oil, pumpkin see oil, mustard seed oil, and modified versions of such oils.

In certain embodiments, the first and second modified bio-based reactive acrylic monomers comprise a modified vegetable oil alkyl ester, a modified vegetable oil aryl ester, or combinations thereof. The bio-based alkyl ester may be selected from the group consisting of a methyl ester, an ethyl ester, a propyl ester, a butyl ester and combinations thereof. In certain embodiments, the first and second bio-based acrylic monomers comprise a vegetable oil methyl ester, an epoxidized vegetable oil, an epoxidized vegetable oil methyl ester, or combinations thereof.

In certain embodiments, disclosed is a bio-based reactive monomer having the general chemical structure R′(O)OR″, wherein R′(O)O is a fatty acid derived from a plant oil, such as vegetable oil, seed oil, animal oil or combinations thereof, and R″ is a linear or branched alkyl, cycloaliphatic or aromatic group. In certain embodiments, R′(O)O contains a heteroatom separate from the ester group. In further embodiments, R′(O)O does not contain a heteroatom separate from the ester group. In yet further embodiments, R″ contains a heteroatom. In other embodiments, R″ does not contain a heteroatom.

In certain embodiments, a bio-based oil alkyl ester, for example, derived from a plant, such as vegetable, a seed or an animal, is prepared by first treating the bio-based oil with catalytic sodium hydroxide and methanol to transesterify the triglycerides and remove the glycerine. The unsaturation is then epoxidized with a sulfuric acid catalyzed hydrogen peroxide/formic acid treatment. In certain embodiments, the epoxidation includes one or more of: Prilezhaev reaction, acid ion exchange resins (AIER), chemoenzymatic epoxidation, or metal-catalyzed systems. Acrylic groups are then introduced by the reaction of the epoxidized methyl ester with acrylic acid in the presence of a radical inhibitor. A catalyst, such as triethylamine (TEA) or triphenylphosphine oxide, may be used during the acrylation step. An inhibitor, such as hydroquinone and 4-methoxyphenol, may be used to avoid any free radical initiated by polymerization through the acrylic groups.

The bio-based reactive monomer may include a long hydrocarbon chain, for example, 12-30 carbon atoms in length, depending on the fatty acid used in the reaction, with an internal or terminal unsaturation site that is capable of free radical polymerization. In certain embodiments, the bio-based reactive monomer is prepared from one or more triglycerides having at least one fatty acid residue with at least one internal unsaturation site. In certain embodiments, the bio-based reactive monomer is prepared from one or more triglycerides having at least one fatty acid residue with at least two internal unsaturation sites. In further embodiments, the bio-based reactive monomer is prepared from one or more triglycerides having at least one fatty acid residue with at least three internal unsaturation sites. In yet further embodiments, the bio-based reactive monomer is prepared from one or more triglycerides having at least one fatty acid residue with at least four internal unsaturation sites. In yet further embodiments, the bio-based reactive monomer is prepared from one or more triglycerides having at least one fatty acid residue with at least five internal unsaturation sites.

Suitable non-limiting saturated fatty acids that may be utilized include propanoic acid, butanoic acid, pentanoic acid, hexanoic acid, heptanoic acid, octanoic acid, nonanoic acid, decanoic acid, undecanoic acid, dodecanoic acid, tridecanoic acid, tetradecanoic acid, pentadecanoic acid, hexadecanoic acid, heptadecanoic acid, octadecanoic acid, nonadecanoic acid, eicosanoic acid, heneicosanoic acid, docosanoic acid, tricosanoic acid, tetracosanoic acid, pentacosanoic acid, hexacosanoic acid, heptacosanoic acid, octacosanoic acid, nonacosanoic acid, triacontanoic acid, hentriacontanoic acid, dotriacontanoic acid, tritriacontanoic acid, tetratriacontanoic acid, pentatriacontanoic acid, hexatriacontanoic acid, heptatriacontanoic acid, octatriacontanoic acid, nonatriacontanoic acid, tetracontanoic acid, or combinations thereof.

Suitable non-limiting monounsaturated fatty acids that may be utilized include cis-Tetradec-9-enoic acid, cis-Hexadec-9-enoic acid, cis-Octadec-11-enoic acid, trans-Octadec-11-enoic acid, cis-13-Eicosenoic acid, cis-Octadec-9-enoic acid, trans-Octadec-9-enoic acid, cis-Eicos-11-enoic acid, cis-Tetracos-15-enoic acid, trans-Tetracos-15-enoic acid, cis-Tetracos-15-enoic acid, cis-6-Hexadecenoic acid, cis-9-Icosenoic acid, cis-Octadec-6-enoic acid, or combinations thereof.

Suitable non-limiting omega-3 polyunsaturated fatty acids that may be utilized include all-cis 7,10,13-hexadecatrienoic acid, all-cis-9,12,15-octadecatrienoic acid, all-cis-6,9,12,15-octadecatetraenoic acid, all-cis-11,14,17-eicosatrienoic acid, all-cis-8,11,14,17-eicosatetraenoic acid, all-cis-5,8,11,14,17-eicosapentaenoic acid, all-cis-6,9,12,15,18-heneicosapentaenoic acid, all-cis-7,10,13,16,19-docosapentaenoic acid, all-cis-4,7,10,13,16,19-docosahexaenoic acid, all-cis-9,12,15,18,21-tetracosapentaenoic acid, all-cis-6,9,12,15,18,21-tetracosahexaenoic acid, or combinations thereof.

Suitable non-limiting omega-6 polyunsaturated fatty acids that may be utilized include all-cis-9,12-octadecadienoic acid, all-cis-6,9,12-octadecatrienoic acid, all-cis-11,14-eicosadienoic acid, all-cis-8,11,14-eicosatrienoic acid, all-cis-5,8,11,14-eicosatetraenoic acid, all-cis-13,16-docosadienoic acid, all-cis-7,10,13,16-docosatetraenoic acid, all-cis-4,7,10,13,16-docosapentaenoic acid, all-cis-9,12,15,18-tetracosatetraenoic acid, all-cis-6,9,12,15,18-tetracosapentaenoic acid, or combinations thereof.

Suitable non-limiting omega-9 polyunsaturated fatty acids that may be utilized include cis-9-octadecenoic acid, cis-11-eicosenoic acid, all-cis-5,8,11-eicosatrienoic acid, cis-13-docosenoic acid, cis-15-tetracosenoic acid, or combinations thereof.

Suitable non-limiting conjugated fatty acids having two or more conjugated double bonds that may be utilized include 9Z,11E-octadeca-9,11-dienoic acid, 10E,12Z-octadeca-10,12-dienoic acid, 8E,10E,12Z-octadecatrienoic acid, 8E,10E,12E-octadecatrienoic acid, 8Z,10E,12Z-octadecatrienoic acid, 9Z,11E,13E-octadeca-9,11,13-trienoic acid, 9E,11E,13E-octadeca-9,11,13-trienoic acid, 9Z,11Z,13E-octadeca-9,11,13-trienoic acid, 9Z,11E,13Z-octadeca-9,11,13-trienoic acid, 9E,11Z,15E-octadeca-9,11,15-trienoic acid, 9E, 11Z, 13Z, 15E-octadeca-9,11,13,15-tetraenoic acid, all trans-octadeca-9,11,13,15-tetraenoic acid, 5Z,8Z,10E,12E,14Z-eicosapentaenoic acid, or combinations thereof.

Other suitable polyunsaturated fatty acids include (5Z,9Z,12Z)-octadeca-5,9,12-trienoic acid, (5Z,11Z,14Z)-eicosa-5,11,14-trienoic acid, or combinations thereof.

According to certain illustrative embodiments, the composition comprises first and optional second modified bio-based reactive acrylic monomers in an amount from about 0.1 to about 99 weight percent based on the total weight of the composition. In certain embodiments, the composition comprises first and optional second modified bio-based reactive acrylic monomers in an amount from about 1 to about 70 weight percent, based on the total weight of the composition. In further embodiments, the composition comprises first and optional second modified bio-based reactive acrylic monomers in an amount from about 5 to about 60 weight percent, based on the total weight of the composition. In yet further embodiments, the composition comprises first and optional second modified bio-based reactive acrylic monomers in an amount from about 10 to about 50 weight percent, based on the total weight of the composition. In yet further embodiments, the composition comprises first and optional second modified bio-based reactive acrylic monomers in an amount from about 10 to about 40 weight percent, based on the total weight of the composition. In yet further embodiments, the composition comprises first and optional second modified bio-based reactive acrylic monomers in an amount from about 15 to about 35 weight percent, based on the total weight of the composition. In yet further embodiments, the composition comprises first and optional second modified bio-based reactive acrylic monomers in an amount from about 25 to about 35 weight percent, based on the total weight of the composition.

Bio-based reactive acrylic monomers useful with the compositions described herein include monomers containing bio-based carbon. Bio-based reactive acrylic monomers useful with the compositions described herein include reactive acrylic monomers containing 25 weight percent or greater, 30 weight percent or greater, 35 weight percent or greater, 40 weight percent or greater, 45 weight percent or greater, 50 weight percent or greater, 55 weight percent or greater, 60 weight percent or greater, 65 weight percent or greater, 70 weight percent or greater, 75 weight percent or greater, 80 weight percent or greater, 85 weight percent or greater, 90 weight percent or greater, or 95 weight percent or greater biobased carbon, based on the total carbon content. As used herein the term bio-based carbon refers to carbon obtained from a biological source rather than a fossil fuel based source. The bio-based content of a monomer, a copolymer, or a copolymer composition can be determined using a method such as ASTM D6866-08. ASTM D6866-08 provides three different methods for determining the bio-based content of a solid, liquid, or gaseous composition. For example, the compositions described herein can be dried as a film and tested as a solid. As defined by ASTM D6866-08, bio-based content is the amount of bio-based carbon in the material or product as a percent of the weight (mass) of the total organic carbon in the product. In particular, ASTM D6866-08 Method B measures the ratios of 14C/12C and 13C/12C in the composition using Accelerator Mass Spectrometry (AMS) and Isotope Ratio Mass Spectrometry (IRMS). Fossil based carbon contains essentially no 14C because its age is much greater than the 5,730 year half-life of 14C. Thus, the presence and level of 14C in a composition provides a direct measure of the amount of carbon that originated from a source other than a fossil fuel, i.e., the level of bio-based carbon in the composition.

In certain embodiments, the composition comprises 10 weight percent or greater, 15 weight percent or greater, 20 weight percent or greater, 25 weight percent or greater 30 weight percent or greater, 35 weight percent or greater, 40 weight percent or greater, 45 weight percent or greater, 50 weight percent or greater, 55 weight percent or greater, 60 weight percent or greater, 65 weight percent or greater, 70 weight percent or greater, 75 weight percent or greater, 80 weight percent or greater, 85 weight percent or greater, 90 weight percent or greater, or 95 weight percent or greater bio-based carbon, based on the total carbon content in the composition.

According to certain illustrative embodiments, the first and second modified bio-based reactive acrylic monomers are present in the composition in a weight ratio from about 1:5 to about 5:1. In certain embodiments, the first and second modified bio-based reactive monomers are present in the composition in a weight ratio from about 1:4 to about 4:1. In further embodiments, the first and second modified bio-based reactive monomers are present in the composition in a weight ratio from about 1:3 to about 3:1. In yet further embodiments, the first and second modified bio-based reactive monomers are present in the composition in a weight ratio from about 1:2 to about 2:1. In yet further embodiments, the first and second modified bio-based reactive monomers are present in the composition in a weight ratio from about 1:1.

The first and optional second modified bio-based reactive acrylic monomers may be polymerized by free-radical polymerization via an initiator. The term “polymerization” as used herein refers to the process of converting a monomer or a mixture of monomers into a polymer. The term “initiator” as used refers to a chemical species that, under the action of an external stimulus (for example light or heat) generates a reaction intermediate from a stable molecule which can start the polymerization of monomers into polymers. In certain embodiments, disclosed is a photoinitiated composition, wherein free-radical polymerization is initiated by ultraviolet (UV) light.

In certain embodiments, the initiator is a thermally activated initiator. According to this embodiment, the composition is a two-part composition, wherein the first part comprises a composition including modified bio-based reactive acrylic monomers, and the second part comprises at least one initiator. In certain embodiments, the initiator is a chemical initiator. For example, the chemical initiator may form free radicals that can decompose above the thermal activation temperature (e.g., higher than 50° C.) to cause free-radical polymerization of the monomers.

The initiator may include any peroxide known in the art capable of initiating free-radical polymerization. In certain embodiments, the composition comprises at least one peroxide initiator selected from the group consisting of benzoyl peroxide, methyl ethyl peroxide, methyl ethyl ketone peroxide, di-t-butyl peroxide, lauroyl peroxide, acetyl peroxide, diisopropyl peroxydicarbonate, bis(4-t-butylcyclohexyl) peroxydicarbonate, t-butyl peroxy-2-ethylhexanoate, t-hexyl peroxy-2-ethylhexanoate, 2,2′-azobisisobutyronitrile, dimethyl 2,2′-azobis(2-methylpropionate), 2,2′-azobis(2-methylbutyronitrile), 2,2′-azobis(2,4-dimethylvaleronitrile), 4,4′-azobis(4-cyanopentanoic acid), and mixtures thereof. Suitable initiators are commercially available from Soprema Inc. (Ohio, USA) under the designation ALSAN®RS Catalyst Powder.

In certain embodiments, the composition is UV curable and may further include a photoinitiator. Suitable non-limiting photoinitiators include: Type I (benzoin ethers, benzil ketals, alpha-dialkoxyacetophenones, alpha-hydroxyalkyl phenones, alpha-amino alkyl phenones, acyl-phosphine oxides) and Type II (Benzophenones/amines, Thioxanthones/amines) and visible photoinitiators. Particular suitable photoinitiators include, without limitation, acetophenone, anisoin, anthraquinone, benzene tricarbonylchromium, benzil, benzoin, benzoin ethyl ether, benzophenone, 3,3′4,4′-Benzophenonetetracarboxylic dianhydride, 4-Benzoylbiphenyl, 2-Benzyl-2-(dimethylamino)-4′-morpholinobutyrophenone, 4,4′-Bis(diethylamino)benzophenone, 4,4′-Bis(dimethylamino)benzophenone, camphorquinone, 2-Chlorothioxanthene-9-one, (Cumene)cyclopentadienyliron (II) hexafluorophophate, dibenzosuberenone, 2,2-Diethoxyacetophenone, 4,4-Dihydroxybenzophenone, thioxanthen-9-one, 2,2-Dimethoxy-2-phenylacetophenone, 4-(Dimethylamino)benzophenone, 4,4′-Dimethylbenzil, 2,5-Dimethylbenzophenone, 3,4-Dimethylbenzophenone, 4′-Ethoxyacetophenone, ferrocene, 3′-Hydroxyacetophenone, 4′-Hydroxyacetophenone, 3-Hydroxybenzonphenone, 4-Hydroxybenzonphenone, 1-Hydroxycyclohexyl phenyl ketone, 2-Hdroxy-2-methylpropiophenone, 2-Methylbenzophenone, 3-Methylbenzophenone, Methylbenzoylformate, 2-Methyl-4′-(methylthio)-2-morpholinopropiophenone, Phenanthrenequinone, 4-Phenoxyacetophenone, Triarylsulfonium hexafluoroantimonate salts, Triarylsulfonium hexafluorophosphate salts, or combinations thereof.

The composition can be field-applied and is suitable for cold curing. According to certain illustrative embodiments, a roofing and waterproofing system can be obtained by applying the composition to a substrate and curing the composition at a temperature in the range of from about −10° C. to about +55° C. According to certain illustrative embodiments, curing of the composition can occur at a temperature in the range of from about −5° C. to about +45° C. In certain embodiments, curing of the composition can occur at a temperature in the range of from about 0° C. to about +35° C. In further embodiments, curing of the composition can occur at ambient temperature, e.g., +10° C. to +30° C.

The composition may comprise an accelerator and/or a peroxide initiator for polymerization of the monomers. The amounts in which these accelerators and/or initiators are added is dependent on the respective system. An initiator is utilized to react with the modified bio-based reactive monomer to create an unpaired electron, and the bio-based reactive acrylate monomers begin to chemically link together forming a longer polymeric chain. Polymerization continues as the modified bio-based monomers react with the free radical on the end of the polymer chain. In certain embodiments, the composition may be prepared via bulk polymerization, emulsion polymerization, suspension polymerization, or solution polymerization.

According to certain illustrative embodiments, at least one initiator is mixed with the composition immediately prior to use of the composition. The composition may comprise reactive monomers, reactive polymers, and mixtures of reactive monomers and reactive polymers. The composition may further include unreactive acrylic polymer in an amount from about 5 to about 40 weight percent, based on the total weight of the composition. In certain embodiments, the composition comprises unreactive acrylic polymer in an amount from about 10 to about 30 weight percent, based on the total weight of the composition.

In certain embodiments, at least one initiator is added to the composition in an amount from about 0.1 to about 20 weight percent, based on the total weight of the composition. According to certain illustrative embodiments, at least one initiator is added to the composition in an amount from about 0.5 to about 10 weight percent, based on the total weight of the composition. In further embodiments, at least one initiator is added to the composition in an amount from about 1 to about 8 weight percent, based on the total weight of the composition. In yet further embodiments, at least one initiator is added to the composition in an amount from about 2 to about 6 weight percent, based on the total weight of the composition. The amount of initiator added to the composition varies by quantity of modified bio-based reactive monomer to be mixed and by the ambient temperature during mixing and installation.

According to certain illustrative embodiments, the composition comprises at least one accelerator in an amount from about 0.1 to about 10 weight percent, based on the total weight of the composition. In certain embodiments, the composition comprises at least one accelerator in an amount from about 0.5 to about 5 weight percent, based on the total weight of the composition. In certain embodiments, the composition comprises at least one accelerator in an amount from about 0.5 to about 3 weight percent, based on the total weight of the composition. In further embodiments, the composition comprises at least one accelerator in an amount from about 0.25 to about 1 weight percent, based on the total weight of the composition. In yet further embodiments, the composition contains substantially no accelerator. In yet further embodiments, the composition contains no accelerator.

The accelerator may comprise any compound suitable for radical initiated polymerizations. The accelerator may include, but is not limited to, amines and mercaptans such as dimethyl-p-toluidine, diisopropoxy-p-toluidine, N,N-bis-(2-hydroxyethyl)-p-toluidine, dimethylaniline, and glycol dimercaptoacetate, where N,N-bis-(2-hydroxyethyl)-p-toluidine, dimethyl-p-toluidine, and combinations thereof. According to certain illustrative embodiments, the accelerator comprises tertiary amines, such as N,N-dimethylaniline, N,N-dimethyl-p-toluidine, diisopropanol-p-toluidine and triethylamine; polyamines, such as diethylenetriamine, triethylenetetramine, pentaethylenehexamine; thioureas, such as thiourea, ethylene thiourea, benzoyl thiourea, acetyl thiourea and tetramethyl thiourea; organic or inorganic acid salts of metal such as copper, cobalt, manganese and vanadium, and organic chelate compounds of the same metals with acetylacetone or the like; reducing organic compounds such as ascorbic acid and gallic acid; and other known accelerators such as saccharin and salts thereof.

In certain embodiments, the composition contains less than 60 wt. % petroleum-based acrylic monomers, based on the total weight of the composition. In certain embodiments, the composition contains less than 50 wt. % petroleum-based acrylic monomers, based on the total weight of the composition. In certain embodiments, the composition contains less than 40 wt. % petroleum-based acrylic monomers, based on the total weight of the composition. In further embodiments, the composition contains less than 30 wt. % petroleum-based acrylic monomers, based on the total weight of the composition. In further embodiments, the composition contains less than 20 wt. % petroleum-based acrylic monomers, based on the total weight of the composition. In yet further embodiments, the composition contains less than 10 wt. % petroleum-based acrylic monomers, based on the total weight of the composition.

In certain embodiments, the composition is free or substantially free of methyl methacrylate (MMA). While methyl methacrylate is capable of providing desirable reactivity properties, it can also provide an unpleasant odor due to its high volatility. The disclosed modified bio-based reactive monomers can be used as substitutes for methyl methacrylate which represents the major component of the odor nuisance. In addition to their excellent low volatile organic content %-VOC) and low odor attributes, the disclosed composition imparts comparable performance properties to those provided by conventional compositions containing petroleum-based acrylic monomers. According to certain illustrative embodiments, the composition can be used in sensitive building applications such hospitals, schools, nursing homes or other environments with closed spaces or spaces with limited ventilation.

As used herein, the terms “volatile organic content” and “VOC” refer to the volatility of the composition as measured by ASTM D2369-20 Method E. According to certain embodiments, the composition exhibits a VOC level of less than about 50 g/L. In certain embodiments, the composition exhibits a VOC level of less than about 25 g/L. In certain embodiments, the composition exhibits a VOC level of less than about 10 g/L. In certain embodiments, the composition exhibits a VOC level of less than about 5 g/L. In certain embodiments, the composition exhibits a VOC level of less than about 1 g/L. In certain embodiments, the composition exhibits a VOC level of less than about 0.50 g/L. In certain embodiments, the composition exhibits a VOC level of less than about 0.10 g/L.

According to certain illustrative embodiments, the composition is substantially all solids. In certain embodiments, the composition is 100% solids. In further embodiments, the composition is an aqueous emulsion. The composition may include a solvent, such naphtha solvents, aromatic solvents or bio-sourced solvents such as esters. In certain embodiments, the solvent is selected from alkanes, cycloalkanes, toluene, xylene, benzene, methyl ethyl ketone, cumene, mesitylene, styrene, diethylbenzene, ethylbenzene, glycol ethers, or mixtures thereof.

Polymerization reactions can be inhibited by oxygen. This inhibition of polymerization reactions can be prevented or mitigated by including an oxygen barrier additive in the composition. Without limitation, and only by way of illustration, suitable oxygen barrier additives include natural or synthetic waxes. Suitable waxes may include paraffin waxes. Waxes are generally nonpolar substances that dissolve in the uncured composition. With increased crosslinking during polymerization, the wax compatibility with the resin decreases causing the wax to migrate to the surface of the polymerizing composition where it forms a film on the surface of the composition. The wax film on the surface of the composition prevents or mitigates atmospheric oxygen inhibition of the polymerization reactions in the composition.

Suitable non-limiting examples of waxes include paraffin, microcrystalline wax, carnauba wax, beeswax, lanolin, whale oil, polyolefin wax, ceresin, candelilla wax or mixtures thereof. According to certain illustrative embodiments, the composition comprises at least one oxygen barrier additive in an amount from about 0.1 to about 10 weight percent, based on the total weight of the composition. In certain embodiments, the composition comprises at least one oxygen barrier additive in an amount from about 0.5 to about 5 weight percent, based on the total weight of the composition. In certain embodiments, the composition comprises at least one oxygen barrier additive in an amount from about 1 to about 4 weight percent, based on the total weight of the composition. In further embodiments, the composition comprises at least one oxygen barrier additive in an amount from about 1 to about 3 weight percent, based on the total weight of the composition. In yet further embodiments, the composition comprises at least one oxygen barrier additive in an amount from about 1 to about 2 weight percent, based on the total weight of the composition. In yet further embodiments, the composition contains no or substantially no oxygen barrier additive.

The composition may further comprise chain transfer agents, drying agents, binders, fillers, chain extenders, crosslinker agents, defoaming agents, antioxidants, fungicides, mold-release agents, mildewcides, biocides, fire/flame retardants, surface tension additives, inhibitors, anti-slip agents, anti-static agents, impact strength improvers, reinforcing agents, weathering protectants, coloring agents such as pigments, oils, thixotropic agents, dispersing agents, wetting agents, flow-control aids, adhesion promoters, surfactants, biostabilizers, storage stabilizers, UV stabilizers, latent hardeners, cure retarders, or mixtures thereof.

Inhibitors can be added to the composition to protect against undesired premature curing. The inhibitors act as radical chain breaking reagents to capture the radicals that are present and increase the storability of the reactive resin composition. Non-limiting suitable inhibitors include 1,4-dihydroxybenzene, 4-methoxyphenol, 2,5-dichloro-3,6-dihydroxy-1,4-benzoquinone, 1,3,5-trimethyl-2,4,6-tris(3,5-di-tert-butyl-4-hydroxybenzyl)benzene, 2,6-di-tert-butyl-4-methylphenol, 2,4-dimethyl-6-tert-butylphenol, 2,2-bis(3,5-bis(1,1-dimethylethyl)-4-hydroxyphenyl-1-oxoperoxymethyl)), 1,3-propanediyl ester, 2,2′-thiodiethyl-bis(3-(3,5-di-tert-butyl-4-hydroxyphenyl)) propionate, octadecyl-3-(3,5-di-tert-butyl-4-hydroxyphenyl) propionate, 3,5-bis(1,1-dimethylethyl-2,2-methylene)-bis(4-methyl-6-tert-butyl) phenol, tris(4-tert-butyl-3-hydroxy-2,6-dimethylbenzyl)-s-triazine-2,4,6 (1H,3H,5H)-trione, tris(4-tert-butyl-3-hydroxybenzene, or mixtures thereof.

c at least one inhibitor in an amount from about 0.0001 to about 5 weight percent, based on the total weight of the composition. In certain embodiments, the composition comprises at least one inhibitor in an amount from about 0.001 to about 3 weight percent, based on the total weight of the composition. In further embodiments, the composition comprises at least one inhibitor in an amount from about 0.01 to about 2 weight percent, based on the total weight of the composition. In yet further embodiment, the composition comprises at least one inhibitor in an amount from about 0.1 to about 1 weight percent, based on the total weight of the reactive resin composition.

Suitable filler includes a material that may be a solid and is inert to other materials in the formulation. In certain embodiments, the filler comprises a mineral filler. In such embodiments, the mineral filler may be selected from the group consisting of silica, chalk, talc, dolomite, kaolin, and combinations thereof. For purposes of illustration, but not by way of limitation, the filler may comprise at least one of recycled fillers, organic fibers, inorganic fibers, rubber particles, cork particles, carbon black, titanium dioxide, silicate such as aluminum silicate, zirconium silicate, talc, kaolin, mica, feldspar, nepheline, syslite, wollastonite, glass, glass spheres, crushed glass, amorphous precipitated silica, hydrophilic fumed silica, hydrophobic fumed silica, silicon dioxide in the form of sand, quartz, quartzite, novaculite, perlite, tripoli, and diatomaceous earth, carbide (e.g., SiC), sulfide (e.g., MoS₂, ZnS), titanate (e.g., BaTiO₃), molybdate (e.g., zinc, calcium, barium or strontium molybdates), phosphate (e.g., of zinc, calcium or magnesium phosphates), metal powders, metal oxides, aluminum powder, silver powder, aluminum hydroxide, graphite powder, wood flour, synthetic fiber, basalt fiber, carbon fiber, aramid fiber, polybenzimidazole fiber, PEEK fiber, polyethylene fiber, boron fiber, ceramic fiber, iron particles, zeolites, clays, sulfates, aluminum sulfate, barium sulfate, calcium carbonate, dolomite, calcium sulfate, barites, limestone, wollastonite, perlite, flint powder, kryolite, alumina, alumina trihydrate, polymer granules, polymer powders, granulated or micronized polyethylene, granulated or micronized polypropylene, melamine, polypropylene fibers, nylon fibers, zinc oxide or mixtures thereof.

According to certain illustrative embodiments, the composition comprises at least one filler in an amount from about 0 to about 60 weight percent, based on the total weight of the composition. In certain embodiments, the composition comprises at least one filler in an amount from about 1 to about 50 weight percent, based on the total weight of the composition. In further embodiments, the composition comprises at least one filler in an amount from about 1 to about 40 weight percent, based on the total weight of the composition. In yet further embodiments, the composition comprises at least one filler in an amount from about 1 to about 30 weight percent, based on the total weight of the composition. In yet further embodiments, the composition comprises at least one filler in an amount from about 10 to about 30 weight percent, based on the total weight of the composition. In yet further embodiments, the composition comprises at least one filler in an amount from about 15 to about 25 weight percent, based on the total weight of the composition. In yet further embodiments, the composition comprises at least one filler in an amount from about 10 to about 50 weight percent, based on the total weight of the composition. In yet further embodiments, the composition comprises at least one filler in an amount from about 20 to about 40 weight percent, based on the total weight of the composition. In yet further embodiments, the composition comprises at least one filler in an amount from about 25 to about 35 weight percent, based on the total weight of the composition.

The composition may further include at least one antioxidant. In certain embodiments, the composition comprises at least one antioxidant in amount of from about 0.001 to about 5 weight percent, based on the total weight of the composition.

The composition may further include at least one crosslinking agent. The term “cross-linking” as used refers to the process of converting a monomer or a mixture of monomers, a polymer or a mixture of polymers, into a cross-linked network. Suitable non-limiting examples of crosslinking agents include polyfunctional methacrylates such as allyl methacrylate, ethylene glycol dimethacrylate, diethylene glycol dimethacrylate, triethylene glycol dimethacrylate, tetraethylene glycol dimethacrylate, polyethylene glycol dimethacrylate, 1,3-butanediol dimethacrylate, 1,4-butanediol dimethacrylate, 1,6-hexanediol dimethacrylate, 1,12-dodecanediol dimethacrylate, glycerol dimethacrylate, trimethylolpropane trimethacrylates or mixtures thereof.

The composition may further include at least one coloring agent, such as a pigment or a dye, to provide a desired color to the formulation. The coloring agent which may be dispersed in the composition include any known natural or synthetic pigment that is generally acceptable for use in formulating reactive resin compositions. These pigments include inorganic pigments, organic pigments or mixtures of inorganic and organic pigments. In certain illustrative embodiments, the desired color is achieved by combining at least two coloring agents. The amounts of coloring agents combined may vary in any amount to obtain the desired color. Examples of pigments include, but are not limited to, red iron oxide, yellow iron oxide, black iron oxide, brown iron oxide, titanium dioxide, zinc oxide, zirconium oxide, cerium oxide, chromium oxide, chromium hydroxide, chromium hydrate, manganese violet, ferric ferrocyanide, guanine (natural pearl) mica, sericite, talc, magnesium carbonate, calcium carbonate, alumina hydroxide, barium sulfate, beta-carotene, annatto, chlorophyllin-copper complex, lycopene, henna, bronze powder, (metallic), copper powder (metallic), silver powder (metallic), gold powder (metallic), ultramarine blues, Lake pigments and the like. Carbon black and titanium dioxide may act as both pigments and fillers in the reactive resin composition.

The composition may further include at least one coloring agent in amount of from about 0.1 to about 20 weight percent, based on the total weight of the composition. According to certain illustrative embodiments, the composition comprises at least one coloring agent in amount of from about 1 to about 15 weight percent, based on the total weight of the composition.

The composition may further include at least one UV stabilizer. Suitable non-limiting examples of UV stabilizers include benzophenone derivatives, benzotriazole derivatives, thioxanthonate derivatives, piperidinolcarboxylic ester derivatives, cinnamic ester derivatives or mixtures thereof.

The composition may further include at least one fungicide, mildewcide and/or biocide. Suitable non-limiting examples of fungicides, mildewcides, and biocides, if used in the composition, may comprise, among others, 4,4-dimethyloxazolidine, 3,4,4-trimethyloxazolidine, modified barium metaborate, potassium N-hydroxy-methyl-N-methyldithiocarbamate, 2-(thiocyanomethylthio) benzothiazole, potassium dimethyl dithiocarbamate, adamantane, N-(trichloromethylthio) phthalimide, 2,4,5,6-tetrachloroisophthalonitrile, orthophenyl phenol, 2,4,5-trichlorophenol, dehydroacetic acid, copper naphthenate, copper octoate, organic arsenic, tributyl tin oxide, zinc naphthenate, copper 8-quinolinate, or mixtures thereof.

The composition may also include a defoamer to control the amount of foaming or gas bubbles produced during the polymerization reaction. Suitable examples of defoamers which may be used include, but are not limited to, silicone defoamers, mineral oil/silica defoamers, low surface tension additives, alcohols, hydrocarbons, paraffin-based mineral oils, glycol derivatives, and derivatives of glycolic esters, of acetic esters and of polysiloxanes. Examples of silicone defoamers which may be used include but are not limited to polysiloxane solutions and non-aqueous emulsions of polysiloxanes. Examples of polysiloxane solutions which may be used as a defoamer include but are not limited to a cyclohexanone polysiloxane solution, a diisobutylketone polysiloxane solution and mixtures thereof. An example of a non-aqueous polysiloxane emulsion which may be used as a defoamer is a polysiloxane propylene glycol emulsion. The at least one defoaming agent may be present in an amount of from about 0.001 to about 10 weight percent, based on the total weight of the composition. According to certain illustrative embodiments, the composition comprises at least one defoaming agent in amount of from about 0.01 to about 5 weight percent, based on the total weight of the composition.

The composition may further include at least one flame or fire retardant. The flame or fire retardant material may be selected from any material that delays, inhibits, or slows the spread of fire by suppressing chemical reactions. According to certain embodiments, the flame retardant may comprise antimony compounds, magnesium hydroxide, aluminum hydroxides, aluminum trihydrate, aluminum oxide hydrate, boron compound such as borates, carbonates, calcium carbonates, bicarbonates, inorganic halides, sulfates, organic halogens, organic phosphorous compounds and combinations thereof. Suitable antimony compounds include, without limitation, antimony trioxide, antimony pentoxide and sodium animonate. Organic halogens include, for example, organobromines and organic chlorines. Suitable organobromines include, without limitation, decabromodiphenyl ether and decabromodiphenyl ethane. Suitable organobromines include polymeric brominated compounds such as brominated polystyrenes, brominated carbonate oligomers, brominated epoxy oligomers, tetrabromophthalic anhydride, tetrabromobisphenol and A, hexabromocyclododecane. Suitable organochlorines include, without limitation, derivatives of chlorenic acid and chlorinated paraffins. Suitable organophosphorus compounds include, without limitation, triphenyl phosphate, resorcinol bis(diphenylphosphate), bisphenol diphenyl phosphate, tricresyl phosphate, triarylphosphates, ammonium polyphosphate, trischloropropyl phosphate, red phosphorous, and phosphonates. Suitable phosphonates include, without limitation, dimethyl methylphosphonate, aluminum diethyl phosphonate, and metal phosphonates, phosphates such as triphenyl phosphate, polyammonium phosphate, monoammonium phosphate, or tri (2-chloroethyl)phosphate, exfoliated graphite, acid treated natural graphite flakes, or mixtures thereof.

The composition may comprise at least one flame retardant material in an amount from about 0 to about 60 weight percent, based on the total weight of the composition. According to certain illustrative embodiments, the composition comprises at least one flame retardant material in an amount from about 5 to about 50 weight percent, based on the total weight of the composition. According to certain illustrative embodiments, the composition comprises at least one flame retardant material in an amount from about 10 to about 30 weight percent, based on the total weight of the composition.

Wetting agents, dispersing agents and flow-control aids can be selected from the group of alcohols, hydrocarbons, glycol derivatives, polyethers, polysiloxanes, polycarboxylic acids, saturated and unsaturated polycarboxylic amine amides, and derivatives of glycolic esters, of acetic esters and of polysiloxanes, phthalic acid ester, adipic acid ester, chloroparaffin, urea resin, melamine resin, modified phenolate, and polyglycol urethane.

The composition may further include at least one dispersing agent in an amount from about 0.01 to about 10 weight percent, based on the total weight of the composition. According to certain illustrative embodiments, the composition comprises at least one dispersing agent in an amount from about 0.1 to about 5 weight percent, based on the total weight of the composition. According to certain illustrative embodiments, the composition comprises at least one dispersing agent in an amount from about 0.5 to about 2 weight percent, based on the total weight of the composition.

Additionally provided is a roof system comprising a roof substrate, an optional reinforcing material, and the composition. The phrase “roof system” as used herein refers to, without limitation, balconies, terraces, parking decks, ramps, roofs and the like.

Suitable roof substrates include, by way of example and not in limitation, wood substrates (e.g., plywood, particle board, wafer board, etc.), asphalt substrates, cast bitumen, asphalt-concrete mixtures, cement board substrates, gypsum board substrate, plaster substrates, ceramic substrates, concrete substrates, metal substrates, metal alloy substrates, and composite material substrates.

The roof system may include a reinforcement or reinforcing layer. Non-limiting examples of suitable reinforcing material include polymer films, fiberglass fabrics, felts, fleeces or mats, or polymer fabrics, felts, fleeces or mats. The at least one reinforcing material may comprise one or more layers. The at least one reinforcing material may be woven or non-woven. According to certain illustrative embodiments, the at least one reinforcing material may comprise porous fabrics, webs or meshes, such as nonwoven polymer sheets for example a nonwoven polyester or a nonwoven fiberglass matt, or a woven or nonwoven fiberglass mesh or grid. According to certain illustrative embodiments, the at least one reinforcing material comprises polymer fibers, for example polyolefin (e.g., polyethylene and polypropylene), polystyrene, vinyl, polyvinyl chloride (PVC), or nylon, from fibers, such as fiberglass, basalt fibers, and aramid fibers or from composite materials, such as carbon fibers in polymeric materials or from inorganic fibers. A suitable reinforcing layer comprising a non-woven polyester material is commercially available from Soprema Inc. (Ohio, USA) under the designation ALSAN®RS Fleece.

According to certain illustrative embodiments, the roof system comprises a roof substrate and the composition applied directly to at least a portion of the surface of the roof substrate.

According to certain illustrative embodiments, the roof system comprises a roof substrate, the composition applied to at least a portion of the roof substrate, and at least one reinforcing material applied on top of at least a portion of the composition.

According to certain illustrative embodiments, the roof system may include more than one layers of reinforcing material. The roof system may thus be considered to include multiple layers, or a layer that is comprised of multiple layers of reinforcing material. According to certain illustrative embodiments, the reinforcing material absorbs at least a portion of the composition and forms a chemical bond between layers of reinforcing material.

According to certain illustrative embodiments, the composition is mixed with at least one initiator, and the mixture is applied to a substrate. Proper dispersion of the initiator in the composition is important to achieve uniform curing of the composition. According to certain illustrative embodiments, at least one initiator is mixed with the composition for at least five minutes to ensure full dispersion. According to certain illustrative embodiments, at least one initiator is mixed with the composition for at least two minutes to ensure full dispersion.

According to certain illustrative embodiments, the composition is applied to a substrate by spraying, brushing, rolling, squeegeeing, scraping, troweling, extrusion, or combinations thereof.

According to certain illustrative embodiments, the composition is fully cured in about 0.5 to about 5 hours after being applied to a substrate. In certain embodiments, the composition is fully cured in less than 60 minutes after being applied to a substrate. In further embodiments, the composition is fully cured in about 30 minutes after being applied to a substrate. The composition can be rapidly cured by use of an accelerator.

According to certain illustrative embodiments, a slow-speed (200 to 400 rpm) mechanical agitator is utilized to premix a container of the composition for about one to about five minutes, an initiator is then mixed with the composition for about one to about five minutes. The catalyzed composition is then applied to the surface of at least a portion of a substrate.

Additionally disclosed is a kit comprising i) the composition including a first modified bio-based reactive acrylic monomer ii) an optional reinforcing material and iii) an optional initiator. In certain embodiments, the kit does not include an initiator. In such embodiments, the composition is capable of UV curing.

According to certain illustrative embodiments, the kit includes i) a container of the composition, at least one accelerator, at least one filler, at least oxygen barrier additive, at least one crosslinking agent, at least one defoaming agent and at least one dispersing agent, ii) a package of the initiator component, and iii) optionally one or more rolls of reinforcing material.

Any suitable container known in the art may be used to package the composition, the initiator component and optional reinforcing material. Non-limiting examples of suitable containers include bags, jugs, bottles, flexible packaging, jars, cans, drums, buckets, barrels and combinations thereof. The modified bio-based reactive monomer containing composition, the initiator component and optional reinforcing material may be measured and packaged separately, then bundled together to form a kit in an overpack or other suitable container to contain all components.

Additionally disclosed is an adhesive, building envelope, primer, vapor barrier, air barrier, coating, or insulation comprising the modified bio-based reactive resin containing waterproofing composition

### EXAMPLES

The modified bio-based reactive monomer containing composition will be further described in connection with the following examples. It should be noted that the following examples are merely illustrative of certain embodiments of the composition and the examples should not be considered to limit the scope of the claims in any manner.

### Preparation of Conventional Composition Comprising Petroleum-Based Acrylic Monomers (Comparative Example 1)

A conventional reactive monomer containing composition was prepared containing two different petroleum-based acrylic monomers, namely, methyl methacrylate and 2-ethylhexyl acrylate, in amounts of approximately 11 wt. % and 13 wt. %, respectively, based on the total weight of the composition.

### Preparation of Illustrative Inventive Composition Comprising Modified Bio-Based Acrylic Monomer (Inventive Example 2)

A modified bio-based reactive monomer containing composition was prepared using the same acrylic monomers and in the same amounts as in the Comparative Example 1, except the petroleum-based 2-ethylhexyl acrylate was replaced by a modified bio-based acrylic monomer comprising a vegetable oil methyl ester.

### Performance Evaluation—Cure Time at Ambient Conditions

The following film cure characteristics at ambient conditions were obtained:

TABLE 1

| | Bulk | 60 mil film |
|---|---|---|
| | cure time | cure time |
| Example No. | (mins) | (mins) |
| Example 1 (Comparative) | 20.08 | 30.48 |
| Example 2 (Inventive) | 18.35 | 28.17 |

The results showed that Inventive Example 2 achieved a comparable bulk cure time and 60 mil film cure time, as compared to Comparative Example 1. In particular, Inventive Example 2 achieved about a 10% faster bulk cure time and 60 mil film cure time, as compared to Comparative Example 1

### Performance Evaluation—Resin/Fleece/Resin Membrane Cure Time at Ambient Conditions

Comparative Example 1 and Inventive Example 2 were applied to a substrate, a separate reinforcing fleece material was then applied on top of Comparative Example 1 and Inventive Example 2, additional amounts of Comparative Example 1 and Inventive Example 2 were then applied on top of the fleece material. The following membrane cure characteristics at ambient conditions were obtained:

TABLE 2

| | | Resin/fleece/resin |
|---|---|---|
| | Bulk | membrane |
| | cure time | cure time |
| Example No. | (mins) | (mins) |
| Example 1 (Comparative) | 20.32 | 29.75 |
| Example 2 (Inventive) | 17.90 | 28.80 |

The results showed that Inventive Example 2 achieved a comparable bulk cure time and resin/fleece/resin membrane cure time, as compared to Comparative Example 1. In particular, Inventive Example 2 provided about a 13% faster bulk cure time and about a 3.5% faster resin/fleece/resin membrane cure time, as compared to Comparative Example 1.

### Performance Evaluation—Resin/Fleece/Resin Membrane Cure Time at 86° F.

Comparative Example 1 and Inventive Example 2 were applied to a substrate, a separate reinforcing fleece material was then applied on top of Comparative Example 1 and Inventive Example 2, additional amounts of Comparative Example 1 and Inventive Example 2 were then applied on top of the fleece material. The following membrane cure characteristics at 86° F. were obtained:

TABLE 3

| | | Resin/fleece/resin |
|---|---|---|
| | Bulk | membrane |
| | cure time | cure time |
| Example No. | mins | (mins) |
| Example 1 (Comparative) | 11.52 | 20.75 |
| Example 2 (Inventive) | 8.53 | 17.42 |

The results showed that Inventive Example 2 provided a comparable bulk cure time and a faster resin/fleece/resin membrane cure time, as compared to Comparative Example 1. In particular, Inventive Example 2 provided about a 30% faster bulk cure time and about a 17.5% faster resin/fleece/resin membrane cure time, as compared to Comparative Example 1

Performance Evaluation—Tensile Strength and Elongation of Membrane (with Fleece)

The following tensile strength and elongation of membrane values were obtained:

TABLE 4

| Example 1 (Comparative) | | | Example 2 (Inventive) | | |
|---|---|---|---|---|---|
| | Max. | | | Max. | |
| | Load, | | | Load, | |
| | lbf | Elongation | | lbf | Elongation |
| Direction | (kN/m) | (%) | Direction | (kN/m) | (%) |
| Machine | 52.8 (9.2) | 44.1 | Machine | 77.2 (13.5) | 59.1 |
| direction | | | direction | | |
| Cross | 50.5 (8.8) | 69.4 | Cross | 78.12 (13.7) | 82.3 |
| machine | | | machine | | |
| direction | | | direction | | |

The results showed that Inventive Example 2 exhibited superior maximum load and elongation characteristics, as compared to Comparative Example 1.

Inventive Example 2 achieved a machine direction maximum load of about 37.5% higher, as compared to Comparative Example 1. Inventive Example 2 also achieved a machine direction elongation of about 29% higher, as compared to Comparative Example 1.

Inventive Example 2 achieved a cross machine direction maximum load of about 43% higher, as compared to Comparative Example 1. Inventive Example 2 also achieved a cross machine direction elongation of about 17% higher, as compared to Comparative Example 1.

### Preparation of Conventional Composition Comprising Petroleum-Based Acrylic Monomers (Comparative Example 3)

A conventional reactive monomer containing composition was prepared containing two different petroleum-based acrylic monomers, namely, benzyl methacrylate and 2-ethylhexyl acrylate, in amounts of approximately 18 wt. % and 5 wt. %, respectively, based on the total weight of the composition.

### Preparation of Illustrative Inventive Composition Comprising Modified Bio-Based Acrylic Monomer (Inventive Example 4)

A modified bio-based reactive monomer containing composition was prepared using the same acrylic monomers and in the same amounts as in the Comparative Example 3, except the petroleum-based 2-ethylhexyl acrylate was replaced by a modified bio-based acrylic monomer comprising a vegetable oil methyl ester.

### Performance Evaluation—Cure Time at Ambient Conditions

The following film cure characteristics at ambient conditions were obtained:

TABLE 5

| | Bulk | 60 mil film |
|---|---|---|
| | cure time | cure time |
| Example No. | (mins) | (mins) |
| Example 3 (Comparative) | 15.37 | 28.67 |
| Example 4 (Inventive) | 15.17 | 28.15 |

The results showed that Inventive Example 4 achieved a comparable bulk cure time and 60 mil film cure time, as compared to Comparative Example 3.

### Performance Evaluation—Resin/Fleece/Resin Membrane Cure Time at Ambient Conditions

Comparative Example 3 and Inventive Example 4 were applied to a substrate, a separate reinforcing fleece material was then applied on top of Comparative Example 3 and Inventive Example 4, additional amounts of Comparative Example 3 and Inventive Example 4 were then applied on top of the fleece material. The following membrane cure characteristics at ambient conditions were obtained:

TABLE 6

| | | Resin/fleece/resin |
|---|---|---|
| | Bulk | membrane |
| | cure time | cure time |
| Example No. | (mins) | (mins) |
| Example 3 (Comparative) | 16.30 | 29.80 |
| Example 4 (Inventive) | 16.40 | 29.23 |

The results showed that Inventive Example 4 achieved a comparable bulk cure time and resin/fleece/resin membrane cure time, as compared to Comparative Example 3.

While the modified bio-based reactive monomer containing composition, methods of preparing the composition, roof system, and building envelope protection system have been described in connection with various embodiments, it is to be understood that other similar embodiments may be used or modifications and additions may be made to the described embodiments for performing the same function. Furthermore, the various illustrative embodiments may be combined to produce the desired results. Therefore, the present disclosure should not be limited to any single embodiment, but rather construed in breadth and scope in accordance with the recitation of the appended claims. It will be understood that the embodiments described herein are merely exemplary, and that one skilled in the art may make variations and modifications without departing from the spirit and scope of the invention. All such variations and modifications are intended to be included within the scope of the invention as described hereinabove.

1. A composition comprising a first modified bio-based reactive acrylic monomer, and optionally a second different modified bio-based reactive acrylic monomer, wherein the first and second modified bio-based reactive acrylic monomers are present in an amount of about 1 wt. % to about 70 wt. %, based on the total weight of the composition.

2. The composition according to claim 1, wherein the first modified bio-based reactive acrylic monomer is polymerizable by free radical polymerization.

3. The composition according to claim 1, wherein the first and optional second modified bio-based reactive acrylic monomer is derived from a plant oil, a seed oil, an animal oil, microbial oil, or combinations thereof.

4. The composition according to claim 1, wherein the first and optional second modified bio-based reactive acrylic monomer is derived from a vegetable oil.

5. The composition of claim 4, wherein the vegetable oil is selected from at least one of: grapeseed oil, palm oil, sesame oil, safflower oil, sunflower oil, castor oil, soybean oil, linseed oil, peanut oil, olive oil, tobacco seed oil, cottonseed oil, coconut oil, rapeseed oil, canola oil, corn oil, and lesquerella oil and modified versions of such oils.

6. The composition according to claim 1, wherein the first modified bio-based acrylic monomer comprises a vegetable oil alkyl ester.

7. The composition of claim 3, wherein the plant oil, the seed oil, the animal oil, the microbial oil, or fatty acid ester derivatives are epoxidized.

8. (canceled)

9. The composition according to claim 2, wherein the free radical polymerization is initiated by heat or a photoinitiator.

10. The composition according to claim 1, wherein the composition is a two-part composition, wherein the first part comprises the modified bio-based reactive acrylic monomer and the second part comprises at least one initiator.

11. The composition according to claim 10, wherein the at least one initiator is a peroxide initiator selected from the group consisting of benzoyl peroxide, methyl ethyl peroxide, methyl ethyl ketone peroxide, di-t-butyl peroxide, lauroyl peroxide, acetyl peroxide, diisopropyl peroxydicarbonate, bis(4-t-butylcyclohexyl) peroxydicarbonate, t-butyl peroxy-2-ethylhexanoate, t-hexyl peroxy-2-ethylhexanoate, 2,2′-azobisisobutyronitrile, dimethyl 2,2′-azobis(2-methylpropionate), 2,2′-azobis(2-methylbutyronitrile), 2,2′-azobis(2,4-dimethylvaleronitrile), 4,4′-azobis(4-cyanopentanoic acid), and mixtures thereof.

12. The composition according to claim 1, wherein the composition comprises less than 50 wt. % of a petroleum-based acrylic monomer or polymer, based on the total weight of the composition.

13. The composition according to claim 1, wherein the composition is substantially free of methyl methacrylate.

14. The composition according to claim 1, wherein the composition exhibits a VOC level of less than about 50 g/L.

15. The composition according to claim 1, wherein the composition is an emulsion.

16. The composition according to claim 1, wherein the composition is substantially all solids.

17. The composition according to claim 1, wherein the composition is 100% solids.

18. The composition according to claim 1, wherein the first and optional second modified bio-based reactive acrylic monomers are present in an amount of about 15 wt. % to about 40 wt. %, based on the total weight of the composition.

19. The composition according to claim 1, wherein the composition comprises the second bio-based acrylic monomer.

20. (canceled)

21. An adhesive, a component to a building envelope system, a primer, a vapor barrier, an air barrier, a functional coating, a waterproofing coating, a top coat, or insulation comprising the composition according to claim 1.

22. A building envelope protection system comprising:
a substrate; and
the composition of claim 1 applied to at least a portion of the substrate.
